(19) United States
(12) Patent Application Publication
(10) Pub. No.: US 2026/0352582 A1
(43) Pub. Date: Nov. 5, 2026

(54) ACCURATE ASSESSMENT OF COMMUNICATION PERFORMANCE IN A WIRELESS NETWORK

(71) Applicant: Ruckus IP Holdings LLC, Claremont, NC (US)

(72) Inventors: Peter G. Khoury, San Francisco, CA (US); Mark Hamilton, Superior, CO (US)

(73) Assignee: Ruckus IP Holdings LLC, Claremont, NC (US)

(21) Appl. No.: 19/487,611

(22) PCT Filed: May 23, 2024
(86) PCT No.: PCT/US2024/030683

§ 371 Date: Nov. 25, 2025

Related U.S. Application Data
(60) Provisional application No. 63/469,342, filed on May 26, 2023.
(60) Provisional application No. 63/469,375, filed on May 27, 2023.

(51) Int. Cl. H04L 43/0852; H04L 43/106; H04W 84/12

(52) U.S. Cl. CPC H04L 43/0858; H04L 43/106; H04W 84/12

(57) ABSTRACT

An electronic device (such as an access point) is described. During operation, the electronic device may receive a packet associated with a second electronic device, where the packet includes a tag with a timestamp representing a time when the packet was enqueued at a data-link layer or a networking layer in the second electronic device. Then, the electronic device may store a receive timestamp when the packet was received. Next, the electronic device may compute an uplink latency corresponding to a difference between the receive timestamp and the timestamp. In some embodiments, the packet may include an aggregate physical layer protocol data unit (PPDU) with multiple packets. A given packet in the multiple packets may include a second tag with a second timestamp representing a second time when the given packet was enqueued at the data-link layer or the networking layer in the second electronic device.

### FIELD

The described embodiments relate to techniques for accurately assessing communication performance in a wireless network.

### BACKGROUND

Many electronic devices are capable of wirelessly communicating with other electronic devices. For example, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard (which is sometimes referred to as ‘Wi-Fi’), Bluetooth™ from the Bluetooth Special Interest Group of Kirkland, Washington), and/or another type of wireless network.

Starting in Wi-Fi 6, Wi-Fi standards and technology has been moving towards not just achieving higher throughput, but also lower latency. The features in Wi-Fi 7 like Multi-Link Operation (MLO) claim to reduce latency. New standards areas such as quality of service (QoS) management have put in place features meant to identify high priority streams and to reduce the latency of those streams.

One significant challenge for these efforts is assessment of the effectiveness of the protocol and firmware strategies. Assessment is important for two purposes. A Network Operations Center (NOC) or network administrator may want to know the health of their network. A good measure of health may encompass delay metrics and accurate measurements for both uplink and downlink.

Assessment is often also important for feedback, so that a network can properly tune itself. If a certain high-priority data flow is not meeting its desired specifications, then other lower priority flows may need to be throttled (e.g., transmitted with increased latency or a lower data rate) to allow for better service for the high-priority traffic. But if the metrics are inaccurate, then either the lower priority flows may be throttled for no reason or the lower priority flows may be throttled too late, which may impair the performance of the high-priority flows.

Additionally, there is usually significant asymmetry between the uplink and downlink flows. Often, the wireless transmission incurs significant network delays, which often dominates or contributes substantially to the overall delay. An access point may have good metrics about downlink delay, because it can measure the latency between when a packet was enqueued and when it was transmitted. From these measurement statistics, it may know relatively well how well a high-priority flow is being served. However, the same access point may need to balance uplink access and uplink transmissions with downlink medium access, a fact that is typically important beginning in Wi-Fi 6 when the access point can schedule uplink access for a station. The control over medium access by a station means that the access point may have responsibility for the quality of a high-priority uplink flow. Unfortunately, currently an access point usually does not have information about uplink latency.

### SUMMARY

An electronic device (such as an access point) is described. This electronic device includes an interface circuit that wirelessly communicates with a second electronic device. During operation, the electronic device receives a packet associated with the second electronic device, where the packet includes a tag with a timestamp representing a time when the packet was enqueued at Layer 2 (a data-link layer) or Layer 3 (a networking layer) in the second electronic device. Then, the electronic device stores a receive timestamp when the packet was received. Next, the electronic device computes an uplink latency corresponding to a difference between the receive timestamp and the timestamp.

The packet may include an aggregate physical layer protocol data unit (PPDU) with multiple packets, where a given packet in the multiple packets includes a second tag with a second timestamp representing a second time when the given packet was enqueued at Layer 2 or Layer 3 in the second electronic device. Then, the electronic device may unpack the packets from the aggregate PPDU. Moreover, the electronic device may compute uplink latencies corresponding to differences between the receive timestamp and timestamps of the packets, where a given uplink latency corresponds to a difference between the receive timestamp and the second timestamp.

Note that the tag may be included in a header of the packet.

Moreover, the electronic device may track additional latency of the packet during subsequent processing in the electronic device until the packet reaches an egress port in the electronic device. Furthermore, the electronic device may add the additional latency to the uplink latency.

Additionally, the uplink latency may be associated with a mesh network.

In some embodiments, the tag may include a value (such as a current value) of a time synchronization function (TSF) beacon time for a network to which the second electronic device is connected. Moreover, the receive timestamp may include a second value (such as a second current value) of a second TSF beacon time of the electronic device.

Furthermore, the tag may include a third value (such as a third current value) of a time synchronization protocol in a wired network. For example, the time synchronization protocol may include IEEE 1588. Additionally, the receive timestamp may include a fourth value (such as a fourth current value) of a second time synchronization protocol in the wired network.

Additionally, the electronic device may attach (or include) a third tag to a second packet, where the third tag includes a fifth timestamp representing a second time when the third tag was enqueued at Layer 2 or Layer 3 in the electronic device. Then, the electronic device may provide, addressed to the second electronic device, the second packet. Note that fifth timestamp in the second packet may be used by the second electronic device to track downlink latency of the second packet. In some embodiments, the second packet may include a second aggregate PPDU with multiple second packets that include third tags.

Another embodiment provides the second electronic device, which may perform counter operations to those performed by the electronic device. For example, the second electronic device may attach the tag to the packet, where the tag includes the timestamp representing the time when the packet was enqueued at Layer 2 or Layer 3 in the electronic device. Then, the second electronic device may provide, addressed to the electronic device, the packet.

Moreover, the delivering and attaching operations may be performed for the multiple packets. After the attaching operations, the packets may include their own timestamps. Moreover, the second electronic device may aggregate the packets into the aggregate PPDU and may provide the aggregate PPDU addressed to the electronic device.

Furthermore, the second electronic device may receive the second packet associated with the electronic device, where the second packet includes the third tag with the fifth timestamp representing the second time when the second packet was enqueued at Layer 2 or Layer 3 in the electronic device. Then, the second electronic device may store a second receive timestamp when the second packet was received. Next, the second electronic device may compute a downlink latency corresponding to a difference between the second receive timestamp and the fifth timestamp for the second packet.

The second packet may include the second aggregate PPDU with multiple second packets, where a given second packet in the multiple second packets includes a fourth tag with a sixth timestamp representing a third time when the given second packet was enqueued at Layer 2 or Layer 3 in the electronic device. Then, the second electronic device unpacks the second packets from the second aggregate PPDU. Moreover, the second electronic device computes downlink latencies corresponding to differences between the second receive timestamp and sixth timestamps of the second packets, where a given downlink latency corresponds to a difference between the second receive timestamp and the fifth timestamp.

Another embodiment provides a computer-readable storage medium for use with the electronic device or the second electronic device. This computer-readable storage medium may include program instructions that, when executed by the electronic device or the second electronic device, cause the electronic device or the second electronic device to perform at least some of the aforementioned operations.

Another embodiment provides a method. This method includes at least some of the operations performed by the electronic device or the second electronic device.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of a system in accordance with an embodiment of the present disclosure.

FIG. 2 is a flow diagram illustrating an example method for computing an uplink latency in accordance with an embodiment of the present disclosure.

FIG. 3 is a drawing illustrating an example of communication among electronic devices in FIG. 1 in accordance with an embodiment of the present disclosure.

FIG. 4 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device (such as an access point) is described. This electronic device includes an interface circuit that wirelessly communicates with a second electronic device. During operation, the electronic device may receive a packet associated with the second electronic device, where the packet includes a tag with a timestamp representing a time when the packet was enqueued at a data-link layer or a networking layer in the second electronic device. Then, the electronic device may store a receive timestamp when the packet was received. Next, the electronic device may compute an uplink latency corresponding to a difference between the receive timestamp and the timestamp. In some embodiments, the packet may include an aggregate physical layer protocol data unit (PPDU) with multiple packets. A given packet in the multiple packets may include a second tag with a second timestamp representing a second time when the given packet was enqueued at the data-link layer or the networking layer in the second electronic device. Moreover, the electronic device may unpack the packets from the aggregate PPDU, and may compute uplink latencies corresponding to differences between the receive timestamp and timestamps of the packets.

By computing the uplink latency of the packet based at least in part on the timestamp included in the packet and the receive timestamp, the communication techniques may facilitate assessment of communication performance and/or network health. Moreover, the communication techniques may allow the uplink latency of high-priority flows to be reduced. Consequently, the communication techniques may improve the user experience and customer satisfaction of users of the electronic device and/or the second electronic device.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fi®,’ from the Wi-Fi Alliance of Austin, Texas), Bluetooth, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi and Ethernet are used as illustrative examples.

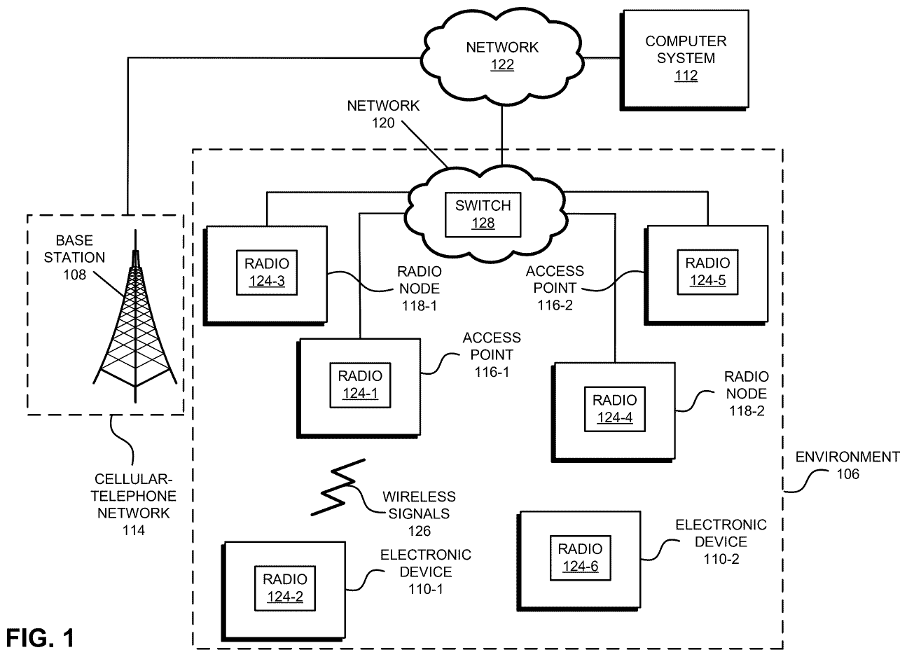

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc.) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, as noted previously, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other and/or optional computer system 112 (which may include one or more computers, and which may be a local or cloud-based controller that manages and/or configures access points 116, radio nodes 118 and/or switch 128, or a cloud-based computer system that provides cloud-based storage and/or analytical services) using a wired communication protocol (such as Ethernet) via network 120 and/or 122. Note that networks 120 and 122 may be the same or different networks. For example, networks 120 and/or 122 may an LAN, an intra-net or the Internet. In some embodiments, network 120 may include one or more routers and/or switches (such as switch 128).

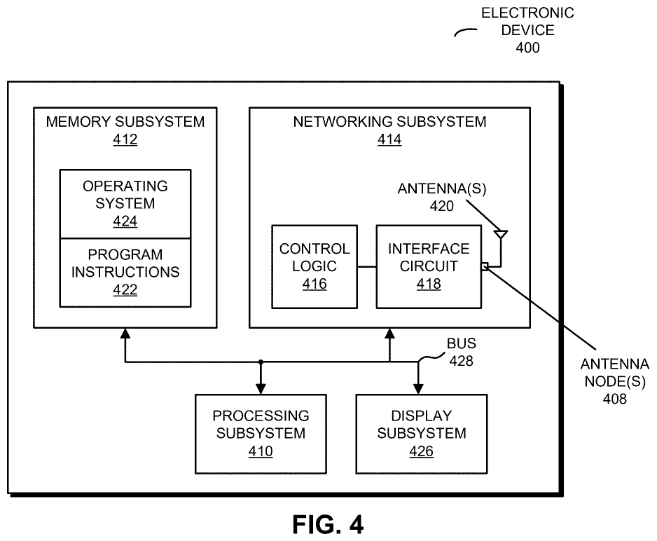

As described further below with reference to FIG. 4, electronic devices 110, computer system 112, access points 116, radio nodes 118 and switch 128 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHZ, 6 GHz, 7 GHz, 60 GHz, the Citizens Broadband Radio Spectrum or CBRS (e.g., a frequency band near 3.5 GHZ), and/or a band of frequencies used by LTE or another cellular-telephone communication protocol or a data communication protocol. Note that the communication between electronic devices may use multi-user transmission (such as orthogonal frequency division multiple access or OFDMA) and/or multiple input, multiple output (MIMO).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, it may be difficult for an access point (such as access point 116-1) to monitor communication performance in a network, such as an uplink latency. In order to address these problems, an access point (such as access point 116-1) and/or an electronic device (such as electronic device 110-1 or a station) may perform the communication techniques.

Notably, electronic device 110-1 may attach a tag to a packet (e.g., in a header of the packet), where the tag includes a timestamp representing the time when the packet was enqueued at Layer 2 or Layer 3 in electronic device 110-1. For example, the timestamp may be a value of a TSF beacon time for a WLAN to which electronic device 110-1 is connected. Then, electronic device 110-1 may provide or transmit, addressed to access point 116-1, the packet.

After receiving the packet, access point 116-1 may store a receive timestamp when the packet was received. Next, access point 116-1 may compute an uplink latency corresponding to a difference between the receive timestamp and the timestamp.

In some embodiments, the packet may include an aggregate PPDU with multiple packets, where a given packet in the multiple packets includes a second tag with a second timestamp representing a second time when the given packet was enqueued at Layer 2 or Layer 3 in electronic device 110-1. For example, electronic device 110-1 may attach tags to multiple packets, which each include their own timestamps. Then, electronic device 110-1 may aggregate the packets into the aggregate PPDU and may provide the aggregate PPDU addressed to access point 116-1. After receiving the aggregate PPDU, access point 116-1 may unpack the packets from the aggregate PPDU. Moreover, access point 116-1 may compute uplink latencies corresponding to differences between the receive timestamp and timestamps of the packets, where a given uplink latency corresponds to a difference between the receive timestamp and the second timestamp.

Moreover, access point 116-1 may track additional latency of the packet during subsequent processing in access point 116-1 until the packet reaches an egress port in access point 116-1. Furthermore, access point 116-1 may add the additional latency to the uplink latency.

Additionally, the uplink latency may be associated with a mesh network.

In some embodiments, the tag may include a value (such as a current value) of a TSF beacon time for a network to which electronic device 110-1 is connected. Moreover, the receive timestamp may include a second value (such as a second current value) of a second TSF beacon time of access point 116-1.

Furthermore, the tag may include a third value (such as a third current value) of a time synchronization protocol in a wired network. For example, the time synchronization protocol may include IEEE 1588. Additionally, the receive timestamp may include a fourth value (such as a fourth current value) of a second time synchronization protocol in the wired network.

Additionally, access point 116-1 may attach a third tag to a second packet, where the third tag includes a fifth timestamp representing a second time when the third tag was enqueued at Layer 2 or Layer 3 in access point 116-1. Then, access point 116-1 may provide, addressed to electronic device 110-1, the second packet. Note that fifth timestamp in the second packet may be used by electronic device 110-1 to track downlink latency of the second packet.

After receiving the second packet, electronic device 110-1 may store a second receive timestamp when the second packet was received. Next, electronic device 110-1 may compute a downlink latency corresponding to a difference between the second receive timestamp and the fifth timestamp for the second packet.

In some embodiments, the second packet may include a second aggregate PPDU with multiple second packets, where a given second packet in the multiple second packets include the third tag with the fifth timestamp representing the second time when the given second packet was enqueued at Layer 2 or Layer 3 in access point 116-1. For example, access point 116-1 may attach third (or fourth) tags to multiple second packets, which each include their own fifth timestamps. Then, access point 116-1 may aggregate the packets into the second aggregate PPDU and may provide the second aggregate PPDU addressed to electronic device 110-1. After receiving the second aggregate PPDU, electronic device 110-1 may unpack the second packets from the second aggregate PPDU. Moreover, electronic device 110-1 may compute downlink latencies corresponding to differences between the second receive timestamp and fifth timestamps of the second packets, where a given downlink latency corresponds to a difference between the second receive timestamp and the fifth timestamp.

In these ways, the communication techniques may allow access points 116 and/or computer system 112 to monitor communication performance in a network. For example, access points 116 and/or computer system 112 may compute uplink and/or downlink latencies associated with traffic or data flows. This capability may allow access points 116 and/or computer system 112 to reduce latencies, such as the latency associated with a high-priority flow. Moreover, the capability may provide information about network health to access points 116 and/or computer system 112. Consequently, the communication techniques may improve the user experience and customer satisfaction of users of the electronic device and/or the second electronic device.

While the preceding discussion illustrated the communication techniques with access point 116-1 and/or electronic device 110-1, in other embodiments at least some of the operations in the communication techniques are performed by computer system 112.

In the described embodiments, processing a frame or a packet in a given one of the one or more access points 116 or a given one of the one or more electronic devices 110 may include: receiving wireless signals 126 with the frame or packet; decoding/extracting the frame or packet from the received wireless signals 126 to acquire the frame or packet; and processing the frame or packet to determine information contained in the frame or packet.

Although we describe the network environment shown in FIG. 1 as an example, in alternative embodiments, different numbers or types of electronic devices or components may be present. For example, some embodiments comprise more or fewer electronic devices or components. Therefore, in some embodiments there may be fewer or additional instances of at least some of the one or more access points 116, the one or more electronic devices 110 and/or computer system 112. As another example, in another embodiment, different electronic devices are transmitting and/or receiving frames or packets.

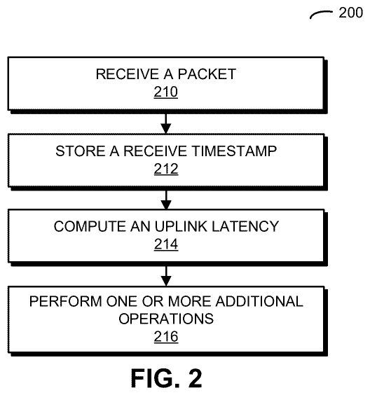

We now describe embodiments of the method. FIG. 2 presents an example of a flow diagram illustrating an example method 200 for computing an uplink latency. Moreover, method 200 may be performed by an electronic device, such as one of access points 116 in FIG. 1, e.g., access point 116-1.

During operation, the electronic device may receive a packet (operation 210) associated with the second electronic device, where the packet includes a tag with a timestamp representing a time when the packet was enqueued at Layer 2 (a data-link layer) or Layer 3 (a networking layer) in the second electronic device. Then, the electronic device stores a receive timestamp (operation 212) when the packet was received. Next, the electronic device computes an uplink latency (operation 214) corresponding to a difference between the receive timestamp and the timestamp.

In some embodiments, the electronic device optionally performs one or more additional operations (operation 216). For example, the packet may include an aggregate PPDU with multiple packets, where a given packet in the multiple packets includes a second tag with a second timestamp representing a second time when the given packet was enqueued at Layer 2 or Layer 3 in the second electronic device. Then, the electronic device may unpack the packets from the aggregate PPDU. Moreover, the electronic device may compute uplink latencies corresponding to differences between the receive timestamp and timestamps of the packets, where a given uplink latency corresponds to a difference between the receive timestamp and the second timestamp.

Note that the tag may be included in a header of the packet. Moreover, the electronic device may track additional latency of the packet during subsequent processing in the electronic device until the packet reaches an egress port in the electronic device. Furthermore, the electronic device may add the additional latency to the uplink latency.

Additionally, the uplink latency may be associated with a mesh network.

In some embodiments, the tag may include a value (such as a current value) of a TSF beacon time for a network to which the second electronic device is connected. Moreover, the receive timestamp may include a second value (such as a second current value) of a second TSF beacon time of the electronic device.

Furthermore, the tag may include a third value (such as a third current value) of a time synchronization protocol in a wired network. For example, the time synchronization protocol may include IEEE 1588. Additionally, the receive timestamp may include a fourth value (such as a fourth current value) of a second time synchronization protocol in the wired network.

Additionally, the electronic device may attach a third tag to a second packet, where the third tag includes a fifth timestamp representing a second time when the third tag was enqueued at Layer 2 or Layer 3 in the electronic device. Then, the electronic device may provide, addressed to the second electronic device, the second packet. Note that fifth timestamp in the second packet may be used by the second electronic device to track downlink latency of the second packet. In some embodiments, the second packet may include a second aggregate PPDU with multiple second packets that include third tags.

In some embodiments of method 200, there may be additional or fewer operations. Moreover, there may be different operations. Furthermore, the order of the operations may be changed, and/or two or more operations may be combined into a single operation.

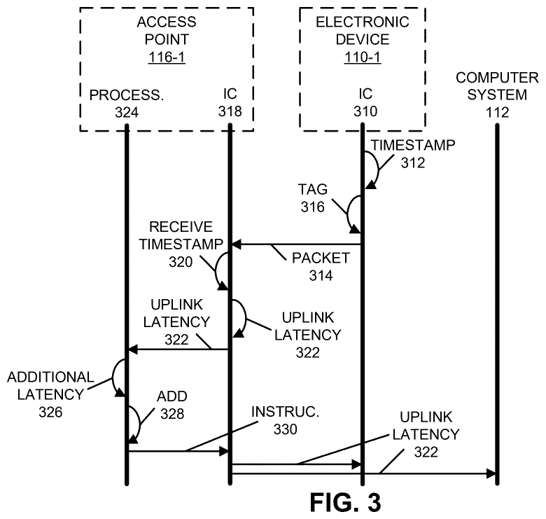

FIG. 3 presents a drawing illustrating an example of communication among electronic device 110-1, computer system 112 and/or access point 116-1. During operation, an interface circuit 310 in electronic device 110-1 may attach a tag 316 (e.g., in a header, such as a Media Access Control or MAC header) to a packet 314, where the tag includes a timestamp 312 representing the time when packet 314 was enqueued at Layer 2 or Layer 3 in electronic device 110-1. For example, timestamp 312 may be a value of a TSF beacon time for a WLAN to which electronic device 110-1 is connected. Then, interface circuit 310 may provide or transmit, addressed to access point 116-1, packet 314.

After receiving packet 314, an interface circuit 318 in access point 116-1 may store a receive timestamp 320 when packet 314 was received. For example, timestamp 320 may be a second value of a second TSF beacon time of access point 116-1. Next, interface circuit 318 may compute an uplink latency 322 corresponding to a difference between receive timestamp 320 and timestamp 312.

In some embodiments, interface circuit 318 may provide uplink latency 322 to processor 324 in access point 116-1. Processor 324 may track additional latency 326 of packet 314 during subsequent processing in access point 116-1 until packet 314 reaches an egress port in access point 116-1. Furthermore, processor 324 may add 328 additional latency 326 to uplink latency 322.

Note that processor 324 may optionally instruct 330 interface circuit 318 to provide uplink latency 322 to electronic device 110-1 and/or computer system 112.

While FIG. 3 illustrates some operations using unilateral or bilateral communication (which are, respectively, represented by one-sided and two-sided arrows), in general a given operation in FIG. 3 may involve unilateral or bilateral communication.

We now further describe the communication techniques. These communication techniques may address the gap or the lack of accurate uplink latency metrics. In some embodiments, the communication techniques may be extended to downlink latency metrics.

The metrics being proposed may measure the time from when a packet was enqueued at Layer 2 or Layer 3 at the transmitting device to the time it was received and/or delivered to the network or higher layers. Let us discuss how this might work with an uplink packet. At the point that the application layer delivers a packet to the Wi-Fi or network driver, the driver may attach an IEEE 802.1 tag to the packet. This IEEE 802.1 tag may include a timestamp representing the time at which the packet was enqueued. For reasons that will become apparent, a useful marker of time may be the current value of the TSF timestamp (which is synchronized via beacons) for the network (such as a WLAN) the client device or station is connected to. Multiple individual packets may be queued up, each with their own timestamp. The Wi-Fi driver may aggregate multiple packets and transmit them together. When the aggregated PPDU is received at the access point, the access point may note the TSF beacon time that the packet was received. The access point may then unpack the individual packets and examine each of the timestamps contained in their headers. The difference between the receive time and the enqueued time may represent the latency for the Wi-Fi transmission and it may be different for each of the packets in the aggregated packets. The access point may continue to track the latency of the packet and keep track of amount of delay as the packet makes its way through the system to the egress port.

In another variation, the delay may be tracked through a mesh network, so the entire delay through the broader wireless system may be tracked. As with the solution mentioned previously, the transmitting access point may timestamp using the TSF of the receiving access point in a mesh network. In another variation, the packet delay may be tracked through the wired network delays. In this later variation, the packets may be stamped using clocks that were synchronized using a time synchronization protocol, such as IEEE 1588.

The same sort of technique may be used on downlink to provide downlink latency information to the client. The access point may attach an IEEE 802.1 tag containing the TSF timestamp to the packet and may possibly aggregate multiple packets and transmit them to the client. The client may then use the TSF of a PPDU receipt and measure the downlink latency of the individual packets.

The latency statistics measured by the access point may be fed back to the client to help them manage the data flow of their applications. For example, as long as the access point deems that it has enough bandwidth to service the client at its desired service level, it may return aggregated latency statistics for both directions, such as mean latency and jitter or percentiles (e.g., 90^{th} and 95^{th} percentiles). If the access point determines that there were more network demands than the access point can service, the access point may start to send throttling requests back to the clients to request that they reduce either their desired bandwidth and/or their desired service interval. If the access point decides it has more bandwidth, it could offer higher levels of service to the client.

The disclosed communication techniques may relate to the Wi-Fi Alliance (WFA) QoS Management program, which introduces QoS characteristics for flows. The QoS characteristics specify service interval (related to latency) and data rate. However, the program currently has no mechanism for measuring actual performance or providing for additional throttling mechanisms on either the access point or the client. The disclosed communication techniques may also relate to mechanisms being considered under the WBA Access Network Metrics project.

We now describe embodiments of an electronic device, which may perform at least some of the operations in the communication techniques. For example, the electronic device may: base station 108, one of electronic devices 110, computer system 112, one of access points 116, one of radio nodes 118, and/or switch 128. FIG. 4 presents a block diagram illustrating an electronic device 400 in accordance with some embodiments. This electronic device includes processing subsystem 410, memory subsystem 412, and networking subsystem 414. Processing subsystem 410 includes one or more devices configured to perform computational operations. For example, processing subsystem 410 can include one or more microprocessors, ASICS, microcontrollers, programmable-logic devices, graphical processor units (GPUs) and/or one or more digital signal processors (DSPs).

Memory subsystem 412 includes one or more devices for storing data and/or instructions for processing subsystem 410 and networking subsystem 414. For example, memory subsystem 412 can include dynamic random access memory (DRAM), static random access memory (SRAM), and/or other types of memory (which collectively or individually are sometimes referred to as a ‘computer-readable storage medium’). In some embodiments, instructions for processing subsystem 410 in memory subsystem 412 include: one or more program modules or sets of instructions (such as program instructions 422 or operating system 424), which may be executed by processing subsystem 410. Note that the one or more computer programs may constitute a computer-program mechanism. Moreover, instructions in the various modules in memory subsystem 412 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 410.

In addition, memory subsystem 412 can include mechanisms for controlling access to the memory. In some embodiments, memory subsystem 412 includes a memory hierarchy that comprises one or more caches coupled to a memory in electronic device 400. In some of these embodiments, one or more of the caches is located in processing subsystem 410.

In some embodiments, memory subsystem 412 is coupled to one or more high-capacity mass-storage devices (not shown). For example, memory subsystem 412 can be coupled to a magnetic or optical drive, a solid-state drive, or another type of mass-storage device. In these embodiments, memory subsystem 412 can be used by electronic device 400 as fast-access storage for often-used data, while the mass-storage device is used to store less frequently used data.

Networking subsystem 414 includes one or more devices configured to couple to and communicate on a wired and/or wireless network (i.e., to perform network operations), including: control logic 416, an interface circuit 418 and one or more antennas 420 (or antenna elements). (While FIG. 4 includes one or more antennas 420, in some embodiments electronic device 400 includes one or more antenna nodes, such as nodes 408, e.g., a pad or connector, which can be coupled to the one or more antennas 420. Thus, electronic device 400 may or may not include the one or more antennas 420.) For example, networking subsystem 414 can include a Bluetooth networking system, a cellular networking system (e.g., a 3G/4G/5G network such as UMTS, LTE, etc.), a USB networking system, a networking system based on the standards described in IEEE 802.11 (e.g., a Wi-Fi networking system), an Ethernet networking system, and/or another networking system.

In some embodiments, a transmit antenna radiation pattern of electronic device 400 may be adapted or changed using pattern shapers (such as reflectors) in one or more antennas 420 (or antenna elements), which can be independently and selectively electrically coupled to ground to steer the transmit antenna radiation pattern in different directions. Thus, if one or more antennas 420 includes N antenna-radiation-pattern shapers, the one or more antennas 420 may have 2^{N} different antenna-radiation-pattern configurations. More generally, a given antenna radiation pattern may include amplitudes and/or phases of signals that specify a direction of the main or primary lobe of the given antenna radiation pattern, as well as so-called ‘exclusion regions’ or ‘exclusion zones’ (which are sometimes referred to as ‘notches’ or ‘nulls’). Note that an exclusion zone of the given antenna radiation pattern includes a low-intensity region of the given antenna radiation pattern. While the intensity is not necessarily zero in the exclusion zone, it may be below a threshold, such as 3 dB or lower than the peak gain of the given antenna radiation pattern. Thus, the given antenna radiation pattern may include a local maximum (e.g., a primary beam) that directs gain in the direction of an electronic device that is of interest, and one or more local minima that reduce gain in the direction of other electronic devices that are not of interest. In this way, the given antenna radiation pattern may be selected so that communication that is undesirable (such as with the other electronic devices) is avoided to reduce or eliminate adverse effects, such as interference or crosstalk.

Networking subsystem 414 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 400 may use the mechanisms in networking subsystem 414 for performing simple wireless communication between the electronic devices, e.g., transmitting frames and/or scanning for frames transmitted by other electronic devices.

Within electronic device 400, processing subsystem 410, memory subsystem 412, and networking subsystem 414 are coupled together using bus 428. Bus 428 may include an electrical, optical, and/or electro-optical connection that the subsystems can use to communicate commands and data among one another. Although only one bus 428 is shown for clarity, different embodiments can include a different number or configuration of electrical, optical, and/or electro-optical connections among the subsystems.

In some embodiments, electronic device 400 includes a display subsystem 426 for displaying information on a display, which may include a display driver and the display, such as a liquid-crystal display, a multi-touch touchscreen, etc.

Electronic device 400 can be (or can be included in) any electronic device with at least one network interface. For example, electronic device 400 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device.

Although specific components are used to describe electronic device 400, in alternative embodiments, different components and/or subsystems may be present in electronic device 400. For example, electronic device 400 may include one or more additional processing subsystems, memory subsystems, networking subsystems, and/or display subsystems. Additionally, one or more of the subsystems may not be present in electronic device 400. Moreover, in some embodiments, electronic device 400 may include one or more additional subsystems that are not shown in FIG. 4. Also, although separate subsystems are shown in FIG. 4, in some embodiments some or all of a given subsystem or component can be integrated into one or more of the other subsystems or component(s) in electronic device 400. For example, in some embodiments program instructions 422 are included in operating system 424 and/or control logic 416 is included in interface circuit 418.

Moreover, the circuits and components in electronic device 400 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’ or a ‘means for communication’) may implement some or all of the functionality of networking subsystem 414 or electronic device 400. The integrated circuit may include hardware and/or software mechanisms that are used for transmitting wireless signals from electronic device 400 and receiving signals at electronic device 400 from other electronic devices. Aside from the mechanisms herein described, radios are generally known in the art and hence are not described in detail. In general, networking subsystem 414 and/or the integrated circuit can include any number of radios. Note that the radios in multiple-radio embodiments function in a similar way to the described single-radio embodiments.

In some embodiments, networking subsystem 414 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals) In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), Open Access (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 422, operating system 424 (such as a driver for interface circuit 418) or in firmware in interface circuit 418. Alternatively or additionally, at least some of the operations in the communication techniques may be implemented in a physical layer, such as hardware in interface circuit 418.

Additionally, while the preceding embodiments illustrated the use of wireless signals in one or more bands of frequencies, in other embodiments of these signals may be communicated in one or more bands of frequencies, including: a microwave frequency band, a radar frequency band, 900 MHz, 2.4 GHz, 5 GHz, 60 GHz, and/or a band of frequencies used by a Citizens Broadband Radio Service or by LTE. In some embodiments, the communication between electronic devices uses multi-user transmission (such as OFDMA).

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the communication technique, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. An electronic device, comprising:
an interface circuit configured to communicate using wireless communication with a second electronic device, wherein the electronic device is configured to perform operations comprising:
receiving a packet associated with the second electronic device, wherein the packet comprises a tag with a timestamp representing a time when the packet was enqueued at a data-link layer or a networking layer in the second electronic device;
storing a receive timestamp when the packet was received; and
computing an uplink latency corresponding to a difference between the receive timestamp and the timestamp.

2. The electronic device of claim 1, wherein the electronic device comprises an access point.

3. The electronic device of claim 1, wherein the packet comprises an aggregate physical layer protocol data unit (PPDU) with multiple packets;
wherein a given packet in the multiple packets comprises a second tag with a second timestamp representing a second time when the given packet was enqueued at the data-link layer or the networking layer in the second electronic device; and
wherein the operations comprise the electronic device unpacking the packets from the aggregate PPDU.

4. The electronic device of claim 3, wherein the operations comprise computing uplink latencies corresponding to differences between the receive timestamp and timestamps of the packets; and
wherein a given uplink latency corresponds to a difference between the receive timestamp and the second timestamp.

5. The electronic device of claim 1, wherein the tag is included in a header of the packet.

6. The electronic device of claim 1, wherein the operations comprise:
tracking additional latency of the packet during subsequent processing in the electronic device until the packet reaches an egress port in the electronic device; and
adding the additional latency to the uplink latency.

7. The electronic device of claim 1, wherein the uplink latency is associated with a mesh network.

8. The electronic device of claim 1, wherein the tag comprises a value of a time synchronization function (TSF) beacon time for a network to which the second electronic device is connected; and
wherein the receive timestamp comprises a second value of a second TSF beacon time of the electronic device.

9. The electronic device of claim 8, wherein the time synchronization protocol comprises Institute of Electrical and Electronics Engineers (IEEE) 1588.

10. The electronic device of claim 1, wherein the tag comprises a value of a time synchronization protocol in a wired network; and
wherein the receive timestamp comprises a second value of a second time synchronization protocol in the wired network.

11. The electronic device of claim 1, wherein the operations comprise:
attaching a second tag to a second packet, wherein the second tag comprises a second timestamp representing a second time when the second tag was enqueued at a data-link layer or a networking layer in the electronic device;
providing, addressed to the second electronic device, the second packet.

12. The electronic device of claim 1, wherein the second packet comprises a second aggregate PPDU with multiple second packets that include third tags.

13. A method for computing uplink latency, comprising:
by an electronic device:
receiving a packet associated with a second electronic device, wherein the packet comprises a tag with a timestamp representing a time when the packet was enqueued at a data-link layer or a networking layer in the second electronic device;
storing a receive timestamp when the packet was received; and
computing the uplink latency corresponding to a difference between the receive timestamp and the timestamp.

14. The method of claim 13, wherein the electronic device comprises an access point.

15. The method of claim 13, wherein the method comprises:
tracking additional latency of the packet during subsequent processing in the electronic device until the packet reaches an egress port in the electronic device; and
adding the additional latency to the uplink latency.

16. An electronic device, comprising:
an interface circuit configured to communicate using wireless communication with a second electronic device, wherein the electronic device is configured to perform operations comprising:
attaching a tag to a packet, wherein the tag comprises a timestamp representing a time when the packet was enqueued at a data-link layer or a networking layer in the electronic device; and
providing, addressed to the second electronic device, the packet.

17. The electronic device of claim 16, wherein the second electronic device comprises an access point.

18. The electronic device of claim 16, wherein the packet comprises multiple packets that, after the attaching operation, each include second tags with their own second timestamps;
wherein the operations comprise:
aggregating the packets into an aggregate physical layer protocol data unit (PPDU); and
providing the aggregate PPDU addressed to the second electronic device.

19. The electronic device of claim 16, wherein the operations comprise:
receiving a second packet associated with the electronic device, wherein the second packet comprises a second tag with a second timestamp representing a second time when the second packet was enqueued at a data-link layer or a network layer in the second electronic device;
storing a receive timestamp when the second packet was received; and
computing a downlink latency corresponding to a difference between the receive timestamp and the second timestamp of the second packet.

20. The electronic device of claim 19, wherein the second packet comprises an aggregate physical layer protocol data unit (PPDU) with multiple third packets;
wherein a given third packet in the multiple third packets comprises a third tag with a third timestamp representing a third time when the given third packet was enqueued at the data-link layer or the network layer in the electronic device;
wherein the operations comprise:
unpacking the third packets from the aggregate PPDU; and
computing downlink latencies corresponding to differences between the receive timestamp and third timestamps of the third packets, wherein a given downlink latency corresponds to a difference between the receive timestamp and the third timestamp.
